(19) United States
(12) Patent Application Publication
(10) Pub. No.: US 2013/0239650 A1
(43) Pub. Date: Sep. 19, 2013

(54) ADVANCED DEVICE FOR INGROUND APPLICATIONS AND ASSOCIATED METHODS

(71) Applicant: MERLIN TECHNOLOGY INC., Kent, WA (US)

(72) Inventors: Albert W. Chau, Woodinville, WA (US); Benjamin John Medeiros, Orting, WA (US); Jason Pothier, Auburn, WA (US); Dmitry Feldman, Seattle, WA (US)

(73) Assignee: Merlin Technology Inc., Kent, WA (US)

(21) Appl. No.: 13/829,731

(22) Filed: Mar. 14, 2013

Related U.S. Application Data
(60) Provisional application No. 61/611,516, filed on Mar. 15, 2012.

(51) Int. Cl. G01P 15/08; G01P 21/00

(52) U.S. Cl. CPC G01P 15/08; G01P 21/00
USPC 73/1.38; 73/497

(57) ABSTRACT

A device is described for use in performing an inground operation. An accelerometer is supported by the device for generating accelerometer readings that characterize the inground operation subject to a native temperature drift of the accelerometer. A set of compensation data is developed and stored for use in compensating for the native temperature drift. The compensation data is applied to the accelerometer readings to produce compensated accelerometer readings that externally compensate for the native temperature drift to yield an enhanced thermal performance which is improved as compared to a native thermal performance of the accelerometer. A seven position calibration method for a triaxial accelerometer is described. An air module is described which isolates the accelerometer of the device at least from a potting compound that at least fills otherwise unoccupied volumes of the device interior.

### RELATED APPLICATION

The present application claims priority from U.S. Provisional Patent Application Ser. No. 61/611,516 filed on Mar. 15, 2012 and which is hereby incorporated by reference in its entirety.

### BACKGROUND

The present invention is at least generally related to the field of devices and associated methods that are adapted to characterize inground operations and, more particularly, to such devices and methods that are related to using one or more accelerometers to characterize such inground operations.

Inground devices such as, for example, transmitters are often located at the distal end of a drill string for use while performing an inground operation. The inground operation, by way of non-limiting example, can be a boring operation for purposes of forming a borehole, in which case the inground device can be housed in the drill head of a boring tool; a pullback operation which may employ a reamer to widen a borehole while pulling a utility therethrough, in which case the inground device can be received in a housing that is adapted for the reaming/pullback operation; or a mapping operation in which the inground device can be caused to transit through a preexisting utility in a suitable manner without the need for a drill string. Typical data that can be transmitted include but are not limited to roll, pitch, yaw, temperature and pressure. In some cases, the parameter of interest can be sensed in a direct way by using a suitable sensor such as, for example, a pressure or temperature sensor. Accelerometers can provide outputs that can be used for purposes of determining the angular orientation of the inground device. As will be further discussed, the accelerometer output can be subject to temperature drift. The selection of an accelerometer for purposes of achieving a particular performance level during an inground operation has traditionally been based on selecting an accelerometer that exhibits a sufficiently low native level of temperature drift over an anticipated range of operational temperatures. In applications that demand relatively high accuracy, the cost of an accelerometer with sufficiently low native temperature drift can become prohibitive.

Ongoing efforts to improve accelerometer-based accuracy have remained focused, in large measure, on the improvement of internal accelerometer structures to further reduce native temperature drift. Hence, the prior art teaches what can be referred to as internal thermal compensation. Unfortunately, these improvements can be complex and still further increase the cost of accelerometers having relatively lower native temperature drift.

In addition to concerns with respect to native temperature drift, Applicants recognize that accelerometer measurement accuracy has been compromised in the past, at least to some extent, by attempts to isolate the accelerometer from the mechanical shock and vibration environment of the inground operation, while the accelerometer and its associated support structure remains exposed to a potentially wide range of operational temperature during the inground operation.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In general, a device and associated method are described for use in performing an inground operation. In one aspect of the disclosure, at least one accelerometer is provided for generating accelerometer readings that characterize an operational condition of the device during the inground operation, which accelerometer readings are subject to a native temperature drift that is a characteristic of the accelerometer. A set of compensation data is developed and stored for use in compensating for the native temperature drift. A processor is configured to apply the compensation data to the accelerometer readings to produce accelerometer readings that compensate for the native temperature drift. In a feature, the application of the compensation data to the accelerometer readings produces thermally compensated accelerometer readings that correspond to an enhanced thermal performance which is improved as compared to a given or native thermal performance of the accelerometer.

In another aspect of the disclosure, a method is described for thermal calibration of a triaxial accelerometer including a set of three orthogonally oriented accelerometers arranged along orthogonal X, Y and Z sensing axes. The method includes supporting the triaxial accelerometer for selective rotation about the orthogonal sensing X, Y and Z axes such that the triaxial accelerometer is orientable in at least twelve different positions for orienting each of the X, Y and Z sensing axes at least approximately to receive four different cardinal gravity-based accelerations. The triaxial accelerometer is exposed to a selected temperature. With the triaxial accelerometer at the selected temperature, outputs of each of the X, Y and Z accelerometers are measured for every cardinal gravity-based acceleration using no more than seven rotational positions of the triaxial accelerometer selected from the sixteen positions.

In still another aspect of the disclosure, a device and associated method are described for use in performing an inground operation with the device including a device housing defining a device interior that carries at least one accelerometer to characterize the inground operation and the device being subject to an operational environment during the inground operation that is characterized by an operational thermal environment. The housing interior is substantially filled by a potting material to fill the housing interior except for any regions that are not accessible to the potting material to protect internal components of the device at least from a mechanical shock and vibration environment of the inground operation. An accelerometer support arrangement and associated method involve a housing that is sealed within the device interior and which housing defines a housing cavity. An accelerometer module defines a support surface that is configured to support the accelerometer and to form an electrical interface with the accelerometer. The accelerometer is supported within the housing cavity within a void at least extending from the support surface and surrounding the accelerometer to isolate the accelerometer from the potting material and from thermal expansion that would otherwise be received from a material within a volume of the void.

### BRIEF DESCRIPTION OF THE FIGURES

Embodiments are illustrated in referenced figures of the drawings. It is intended that the embodiments and figures disclosed herein are to be illustrative rather than limiting.

FIG. 1 is a diagrammatic view, in perspective, of an embodiment of a system for performing accelerometer characterization/calibration according to the present disclosure.

FIG. 2 is a block diagram that illustrates further details of an embodiment of the system of FIG. 1.

FIG. 3 is a block diagram that illustrates an embodiment of an accelerometer module according to the present disclosure.

FIG. 4 is a flow diagram that illustrates an embodiment of a method for accelerometer characterization according to the present disclosure.

FIG. 5 is a diagrammatic, perspective view illustrating an embodiment of a device for use during an inground operation according to the present disclosure.

FIG. 6 is another diagrammatic, perspective view of the embodiment of the device of FIG. 5, shown here to illustrate details of its internal structure.

FIG. 7 is a diagrammatic, perspective view of an embodiment of an air module which houses one or more accelerometers according to the present disclosure.

FIG. 8 is an exploded, diagrammatic view, in perspective, of the embodiment of the air module of FIG. 7, shown here to illustrate details of its internal structure and components.

FIG. 9 is a block diagram of an embodiment of the device of FIGS. 5 and 6 according to the present disclosure.

FIG. 10 is a flow diagram that illustrates an embodiment of a method for the operation of an inground device according to the present disclosure.

FIG. 11 is a diagrammatic, perspective view of another embodiment of an air module according to the present disclosure.

FIG. 12 is a diagrammatic, exploded view, in perspective of still another embodiment of an air module according to the present disclosure.

FIG. 13 is a diagrammatic, assembled view, in perspective, of the embodiment of the air module of FIG. 12.

FIG. 14 is a diagrammatic, exploded view, in perspective of yet another embodiment of an air module according to the present disclosure.

### DETAILED DESCRIPTION

The following description is presented to enable one of ordinary skill in the art to make and use the invention and is provided in the context of a patent application and its requirements. Various modifications to the described embodiments will be readily apparent to those skilled in the art and the generic principles taught herein may be applied to other embodiments. Thus, the present invention is not intended to be limited to the embodiments shown, but is to be accorded the widest scope consistent with the principles and features described herein including modifications and equivalents. It is noted that the drawings are not to scale and are diagrammatic in nature in a way that is thought to best illustrate features of interest. Descriptive terminology such as, for example, up/down, right/left and the like may be adopted for purposes of enhancing the reader's understanding, with respect to the various views provided in the figures, and is in no way intended as being limiting.

While an inground device can be referred to herein as a transmitter, it should be appreciated that the present disclosure is applicable with respect to other suitable forms of the inground device such as, for example, a transceiver. Further, inground devices of a specific type such as transmitters can be offered in a range of embodiments that differ in feature set and/or precision.

When an accelerometer such as three-axis accelerometer is used to sense the angular orientation of the inground device (which can be referred to interchangeably as a sonde), pitch and roll orientation of the device can be determined based on the accelerometer outputs. The accuracy of pitch and roll measurements determined in this way, however, are related at least to accelerometer performance with respect to temperature. As introduced above, this characteristic of accelerometer performance is often referred to as temperature drift, and can contribute a majority of the potential error with respect to angular orientation determinations. Error that is present in roll and pitch orientation determinations based on accelerometer outputs can lead to still further errors. As examples, an error in roll orientation can further introduce error in yaw determinations, when yaw is calculated as a function of roll, while an error in pitch orientation can negatively affect the accuracy of an integrated depth calculation. Moreover, accelerometers are not limited to the application of sensing angular orientation. For example, accelerometers can be used to sense vibration and shock. The compensation technique taught herein is applicable irrespective of the particular task to which the accelerometer data is applied.

The present disclosure brings to light apparatus and processes that are related to external thermal compensation to reduce the adverse effects of accelerometer temperature drift. That is, the teachings herein can provide for improved accuracy in accelerometer-based determinations for a given accelerometer in an inground device, irrespective of the native temperature drift of the given accelerometer. Using the determination of pitch and roll angular orientations by way of non-limiting example, in order to achieve a given degree of angular orientation accuracy in an inground device, the traditional approach has been to select an accelerometer having a corresponding given degree of native temperature drift. That is, native temperature drift has been improved in the prior art generally through internal improvements in the structure of the accelerometer. Hence, the prior art teaches what can be referred to as internal thermal compensation. By applying the teachings herein, however, an accelerometer having a higher degree of native temperature drift can be used to achieve the given performance level. In this regard, Applicants are unaware of inground devices such as, for example, transmitters and transceivers suited to horizontal directional drilling applications that have been configured according to the present disclosure wherein external compensation for accelerometer temperature drift is applied.

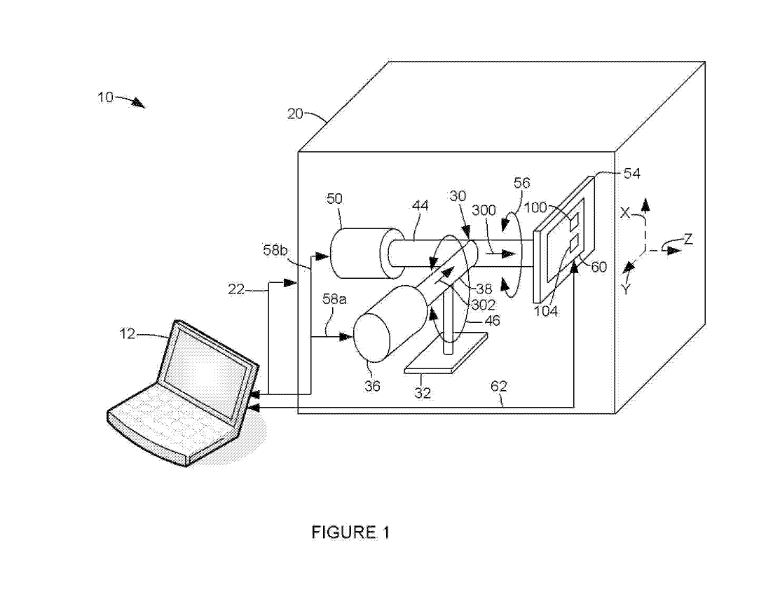

Attention is now directed to the figures wherein like reference numbers may be applied to like items throughout the various views. FIG. 1 is a diagrammatic view, in perspective, of an embodiment of a system according to the present disclosure generally indicated by the reference number 10. The system includes a computer 12 of any suitable type such as, for example, a personal computer including a CPU 14 and a memory 16. The computer is interfaced to an environmental chamber 20 for purposes of establishing the temperature level within the chamber via a control line 22. It should be appreciated that control line 22 can be bidirectional such that computer 12 can receive data from chamber 20, for example, to indicate the current temperature of the interior of the chamber. It should be appreciated that environmental chambers which establish specified/stable temperature levels are well known.

Still referring to FIG. 1, chamber 20 defines a temperature controlled interior that receives a two-axis calibration fixture 30 which includes a base 32 supporting a pitch motor 36 via a pitch motor arm 38. The pitch motor is configured for rotating a roll motor arm 44 as indicated by an arcuate arrow 46. The roll motor arm supports a roll motor 50 at one end while providing a support platter 54 at an opposite end. Rotation provided by roll motor 50 can rotate support platter 54, as indicated by an arcuate arrow 56. The pitch and roll motors are controlled by computer 12 via interfaces 58a and 58b, respectively. Accordingly, support platter 54 can be oriented at any desired angular orientation within the environmental chamber. While the entire calibration fixture has been illustrated as being within the interior of the environmental chamber in the present embodiment, in another embodiment, pitch motor arm 38 can pass through a sidewall of the environmental chamber such that pitch motor 36 can be exterior to the environmental chamber. As will be further described, an accelerometer module 60 is temporarily supported on support platter 54 and interfaced to computer 12 by an interface 62. One of ordinary skill in the art will appreciate that cabling for purposes of electrically interconnecting the various components of the system can be provided in a wide variety of configurations and readily adapted to suit the interface requirements of any particular component that is in use. Typical instrumentation items such as temperature sensors and position detectors have not been shown in FIG. 1 but are understood to be present.

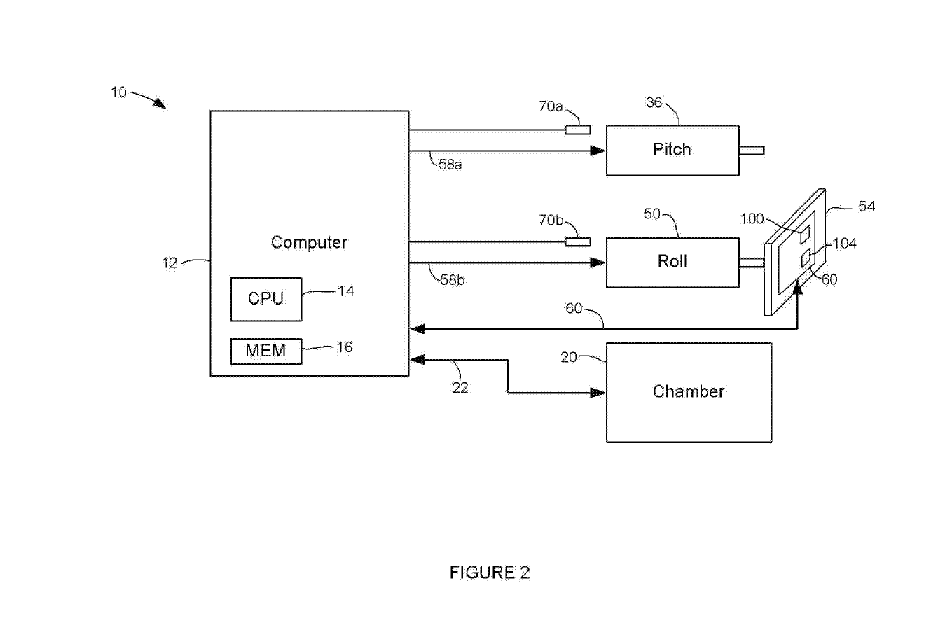

FIG. 2 is a block diagram that further illustrates an embodiment of system 10 additionally illustrating sensor arrangements 70a and 70b in association with pitch motor 36 and roll motor 50, respectively. In an embodiment, each sensor arrangement can comprise, by way of non-limiting example, a set of limit switches that can identify orthogonally opposed positions (0°, 90°, 180° and 270°), which may be referred to below as cardinal positions that are aligned with the orientation of gravity, for each of pitch and roll such that computer 12 is able to set the angular orientation of the support platter to any specified combination of cardinal pitch and roll angles. In another embodiment, sensor arrangements 70a and 70b can comprise position encoders of a desired accuracy.

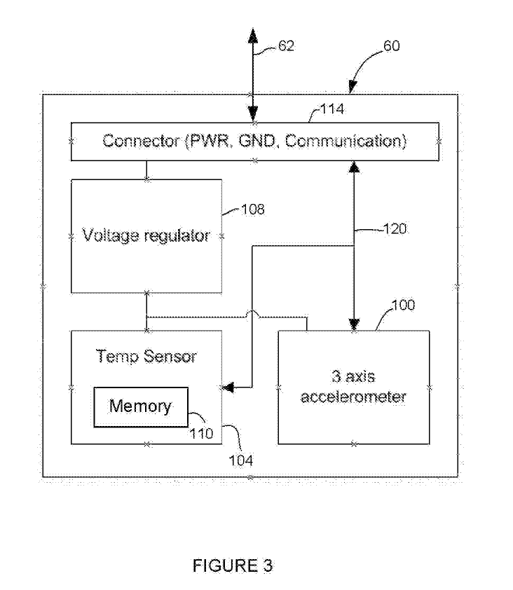

Having described system 10 in detail above, attention is now directed to FIG. 3 which is a block diagram that illustrates an embodiment of accelerometer module 60 in accordance with the present disclosure. One of ordinary skill in the art will appreciate that the module can be constructed, for example, on a suitable printed circuit board. Individual electrical conductors have not been shown since the individual components and interfaces that are selected will dictate requirements in this regard. A three-axis accelerometer 100, as well as a temperature sensor 104, receive electrical power from a voltage regulator 108. It should be appreciated that any suitable accelerometer arrangement can be utilized including three individual accelerometers having orthogonal arranged axes. Temperature sensor 104 can include a memory section 110. In another embodiment, however, memory section 110 can be provided as a separate component. In either case, any suitable type of memory can be used such as, for example, EEPROM. Voltage regulator 108 receives input electrical power and ground from an interface connector 114 that is electrically connected to interface 62 from computer 12 of FIGS. 1 and 2. In an embodiment, interface 62 can be an I²C interface which is a form of serial digital interface. In an embodiment, voltage regulator 108 regulates a 4 volt DC input to 3.3 volts DC. It should be appreciated that the accuracy of the output of accelerometer 100 can be directly dependent upon the regulation stability of the voltage regulator. Moreover, the disclosed thermal compensation accounts for the thermal response of voltage regulator 108, since the regulator is providing power to the accelerometer(s) and subject to the same thermal environment during the procedure. For an embodiment of the accelerometer module without an onboard voltage regulator, the thermal response of the voltage regulator can be characterized individually. In still another embodiment which uses an analog accelerometer(s), an analog to digital converter can be used having a voltage reference input that provides for a ratiometric configuration whether or not an onboard voltage regulator is provided. An internal interface 120 couples interface connector 114 to each of temperature sensor 104, memory 110 and accelerometer 100 such that computer 12 or an end use processing device, described hereinafter, can perform read/write operations on memory 110 as well as read the three axis outputs from accelerometer 100. It is noted that, in an embodiment, internal interface 120 can be an I²C interface as one of a number of options. Temperature sensor 104 can be physically positioned to best match and respond to the temperature environment to which accelerometer 100 is subjected.

Still referring to FIG. 3, characterizing accelerometer 100 for purposes of compensating for thermal drift involves determining correction factors for bias and scale drift such that these correction factors can be applied to the raw output of the accelerometer in an end use. In the present embodiment, the end use involves installation in an inground device such as, for example, a transmitter. As will be seen, the characterization process is performed using system 10 before the accelerometer module is installed in an inground device. The characterization process involves determining coefficients that are stored locally in memory 110 of the accelerometer module such that the accelerometer module can be installed in any suitable end use device that is configured for accessing and using the stored coefficients.

Referring to FIG. 1, the system is initially prepared for performing the characterization/calibration procedure by removably installing module 60 on support platter 54 and electrically connecting the module to interface 62 (see FIG. 3). Three-axis accelerometer 100 includes three native orthogonally opposed sensing axes X,Y,Z that are aligned, at least to an approximation, with rotation axes defined by system 10. Generally, it is acceptable for the subject alignment to be within +/−5°. The sensing axes are shown as offset from accelerometer 100 in FIG. 1 for purposes of illustrative clarity. In the present example, with the accelerometer module installed on platter 54, the Z axis is at least approximately aligned with a machine defined roll calibration axis 300 and the Y axis is at least approximately aligned with a machine defined pitch calibration axis 302. Generally, the calibration process can involve, by way of non-limiting example, collecting accelerometer data at each of five spaced-apart different temperatures starting at −20° C., but a −20° C. starting point is not a requirement. The X, Y and Z accelerometer data is collected temperature-by-temperature after the environmental chamber has stabilized at a currently specified temperature. Temperature sensor 104 of the accelerometer module can be used to monitor the temperature in the chamber. It should be appreciated that a temperature sensor provided as part of the environmental chamber can be used to dictate the temperature step points, but there is no requirement to calibrate the temperature measured by module temperature sensor 104 to the environmental chamber temperature sensor. Accordingly, readings from module temperature sensor 104 can be used to characterize the thermal performance of the accelerometer module at least for the reason that measurements taken by the accelerometer module temperature sensor will provide for consistent results in an end use of the accelerometer module. Thermal performance can be considered as the accuracy, or deviation from 100% or absolute accuracy, of an accelerometer relative to changes in temperature. Enhanced thermal performance can be considered as a reduced deviation from 100% accuracy with changes in temperature. The accelerometer data is collected with the accelerometers oriented at each of the 4-point/cardinal gravity-based accelerations. That is, with each accelerometer sensing axis oriented to each cardinal position: (i) vertically facing up (−1 g, 90°), (ii) vertically facing down (+1 g, 270°), (iii) horizontally facing right (+0 g, 0°), and (iv) horizontally facing left (−0 g, 180°). While the temperatures that are used in the present example are not intended as being limiting, one set of temperatures that make up the overall temperature profile can include:

Ramp to −20° C., collect data at all cardinal positions,

Ramp to 0° C., collect data at all cardinal positions,

Ramp to 20° C., collect data at all cardinal positions,

Ramp to 40° C., collect data at all cardinal positions,

Ramp to 60° C., collect data at all cardinal positions.

It should be appreciated that any suitable number of temperatures can be used that are spaced apart in any suitable manner so long as the selected number of temperatures and their individual values characterize the accelerometer response with sufficient accuracy over the selected temperature range, for example, via population of coefficients of a selected mathematical expression via curve fitting.

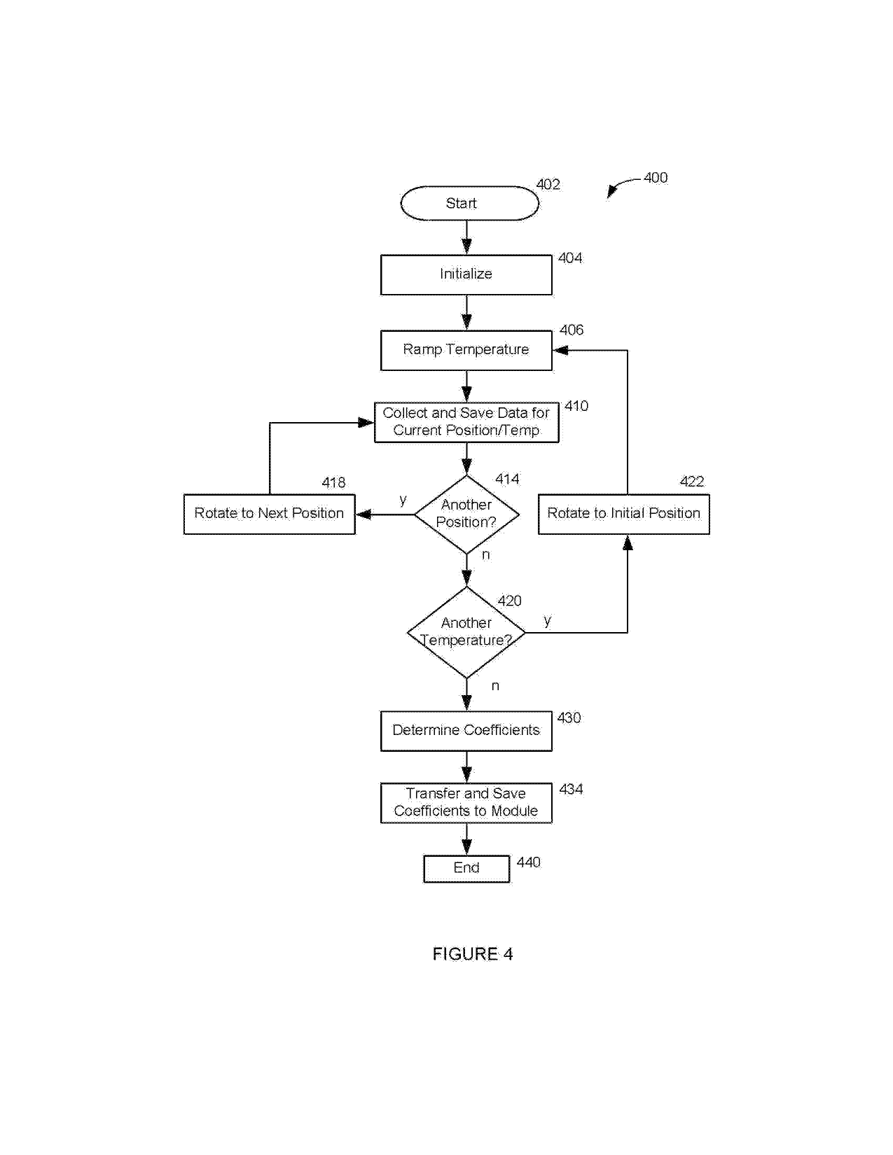

Turning to FIG. 4 in conjunction with FIG. 3, an embodiment of a calibration or characterization process according to the present disclosure is generally indicated by the reference number 400 and can be performed by computer 12. The process begins at start 402 and proceeds to an initialization step 404 which can perform any housekeeping or setup steps that are necessary to prepare system 10 to begin the calibration procedure. For example, the current position of support platter 54 can be determined using sensor arrangements 70a and 70b. If the support platter is not found to be at a desired initial or home position, the position of the platter can be adjusted to such a position. In some cases, the environmental chamber may require orienting the platter to an off axis position for purposes of installing and/or removing module 60 such that it is necessary to reorient the platter during initialization.

At step 406, the temperature in the environmental chamber is ramped to an initial temperature for starting the calibration process. As noted above, in suitable embodiments, either accelerometer temperature sensor 104 or the environmental module temperature sensor can be used to indicate stabilization at the selected temperature. In another embodiment, a sufficient soak time can be provided to allow for stabilization at each temperature based, for example, on empirical determinations. At 410, accelerometer data is collected for each accelerometer by orienting each X,Y,Z sensing axis at each one of the four unique orthogonal/cardinal gravity-based accelerations. It is noted the sensing axes are not required to be positioned to precisely up, down, left or right with respect to gravity, so long as the error from the true orientation is less than a specified tolerance. For the −1 g and +1 g orientations, it is noted that a tolerance of +/−5° provides for a cosine value that is sufficiently near 1. It is of benefit, however, to maintain opposing acceleration/position pairs of +1 g and −1 g or +0 g and −0 g as closely as practical to 180° opposite with respect to one another such that the error is matched, at least from a practical standpoint, for the accelerations of each opposing pair. In an embodiment, sensors 70a and 70b (FIG. 2) can comprise encoders of a suitable resolution for this type of positioning.

The data collection at step 410 can be performed according to Table 1 below. In this regard, Applicants recognize that multiple accelerometer axes can be read while maintaining platter 54 in a single orientation so as to reduce the time needed for gathering data. Thus, instead of positioning each accelerometer axis individually in the four cardinal orientations and measuring the output (4 positions multiplied by 3 axis=12 positions) the process can be reduced to 7 positions for a given temperature set point. It is noted that FIG. 1 illustrates platter 54 in the Position 1 orientation of Table 1.

TABLE 1
Accelerometer Data Collection Matrix

| | Chamber Axis | Chamber Axis | Accelerometer Axis | | |
|---|---|---|---|---|---|
| Position | 300 (Roll) | 302 (Pitch) | X | Y | Z |
| 1 | 0 | 0 | −1 g | +0 g | +0 g |
| 2 | 0 | 90 | −0 g | +1 g | 0 g* |
| 3 | 0 | 180 | +1 g | −0 g | 0 g* |
| 4 | 0 | 270 | +0 g | −1 g | 0 g* |
| 5 | 180 | 0 | +1 g* | 0 g* | −0 g |
| 6 | 90 | 0 | 0 g* | 0 g* | +1 g |
| 7 | 270 | 0 | 0 g* | 0 g* | −1 g |

*denotes uncollected data

After collecting accelerometer data for a current position, operation proceeds to 414 which determines whether another position remains for data collection at the current temperature. If so, operation proceeds to 418 which rotates the platter to the next position according to Table 1. Steps 410 and 414 are then repeated. If step 414 determines that data has been collected for all positions, operation proceeds to 420 which determines whether another temperature is specified for data collection. If so, operation moves to 422 which returns platter 54 to Position 1. Step 406 then ramps the environmental chamber to the next temperature. The procedure then repeats for each additionally specified temperature until step 420 determines that data has been collected for all specified temperatures. At 430, coefficients are determined based on the collected data and can be stored at least temporarily in memory 16 of computer 12. It should be appreciated that there is no requirement to collect data using an ascending order of temperature values and that any suitable order can be used such as, for example, a descending order of progressively decreasing values.

Still describing step 430, according to the present embodiment, each axis is corrected using ten coefficients:

4 coefficients for the 3^{rd} order gain correction

4 coefficients for the 3^{rd} order offset correction

1 coefficient for gain at 20° C.

1 coefficient for offset at 20° C.

It should be appreciated that the use of ten coefficients per accelerometer axis is not intended as limiting and that any suitable number of compensation coefficients and corresponding function can be used. For example, the gain and offset coefficients at 20° C. are not required but can be applied to normalize output values for comparative purposes. Therefore, in some embodiments, only 8 coefficients per accelerometer axis are needed. In an embodiment, the coefficients can be determined as described immediately hereinafter.

### Determination of Thermal Compensation Coefficients

Step 1: Determine Offset function: OS(t)

OS(t)=(V_{0deg}(t)+V_{180deg}(t))/2 (1)

Where t represents temperature while V_{0deg}(t) is equal to the voltage or counts as a function of temperature with the subject axis oriented horizontally, for example, left and V_{180deg}(t) is equal to the voltage or counts as a function of temperature with the subject axis oriented oppositely, for example, to the right. It is noted that these values are represented as −0 g and 0 g, respectively, in Table 1. The term “counts” refers to the output resolution of the accelerometer based on minimum incremental voltage steps wherein each voltage step represents a count.

A third order polynomial fit can be determined to represent the function OS(t). The polynomial fit can be determined, for example, based on the accelerometer output values versus temperature values using the Least Square, Least Absolute Residual or Bisquare method in the form:

OS(t)=At³+Bt²+Ct+D (2)

for a third order polynomial, where A-D represent coefficients with D being constant. In this regard, any suitable curve fitting technique can be used and is not limited to a third order polynomial. Moreover, OS(t) can be represented by a linear function if the associated drift of the accelerometer is linear.

Step 2: Determine Gain function: k(t)

k(t)=(V_{90deg}(t)−V_{270deg}(t))/2 (3)

The gain function is a function of temperature where: V_{90deg}(t) is equal to the voltage or counts as a function of temperature with the subject axis oriented, for example, up and V_{270deg}(t) is equal to the voltage or counts as a function of temperature with the subject axis oriented, for example, down. It is noted that these values are represented as −1 g and 1 g, respectively, in Table 1.

A third order polynomial fit can be determined for k(t) in a manner that is consistent with the descriptions above with respect to representing the function OS(t). Like OS(t), k(t) can be represented by a linear function if the associated drift of the accelerometer is linear.

Step 3: Determine temperature corrected angle, α_{comp}:

α_{comp}=sin⁻¹((V_{RAW}−OS(t))/k(t)) (4)

Where V_{RAW} is equal to the measured voltage or counts from the accelerometer while OS(t) is given by Eqn. (1) and k(t) is given by Eqn. (3).

Step 4: Convert corrected angle back to corrected/compensated voltage or counts:

V_{comp}=(k_{20C}*xin(α_{comp}))+OS_{20C} (5)

Where: V_{comp}=is the compensated acceleration in Volts or counts.

α_{comp}=sin⁻¹((Vₒᵤₜ−OS(t))/k(t))

k_{20C}=the calculated nominal gain at 20° C.

OS_{20C}=the calculated nominal offset at 20° C.

It is noted that Step 4 may not be required but has nevertheless been provided at least for purposes of completeness.

Having determined the coefficients as part of step 430 of FIG. 4, operation proceeds to 434 which transfers the coefficients from the memory of computer 12 to memory 110 of the accelerometer module. The calibration process concludes at 440.

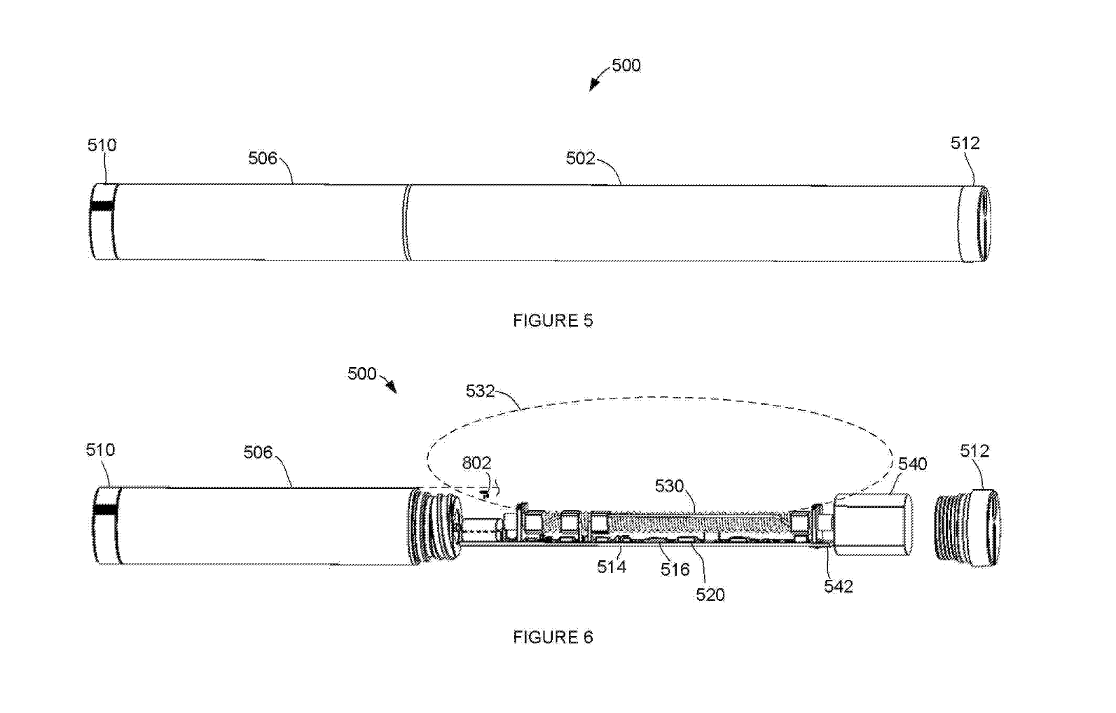

Attention is now directed to FIG. 5 which is a diagrammatic view, in perspective, of an embodiment of an inground device, generally indicated by the reference number 500, produced in accordance with the present disclosure. Device 500, by way of non-limiting example, is a transmitter including a main housing body 502 and a battery compartment housing body 506. The battery and main housing bodies can be configured for threaded engagement. A first end cap 510 is removably received on the battery compartment housing for purposes of replacing batteries therein. A second end cap 512 is received on an outward end of main housing body 502.

Referring now to FIG. 6, transmitter 500 is illustrated in another diagrammatic perspective view with main housing body 502 rendered as transparent so as to illustrate the interior components of the transmitter. In particular, a main printed circuit board 514 includes any suitable arrangement of electronic components such as, for example, a processor 516 and a memory 520. In this regard, it should be appreciated that in an embodiment, accelerometer(s) 100 (FIGS. 1 and 2) and associated components of the accelerometer can be mounted directly on main board 514 and the aforedescribed thermal calibration process applied to the entire assembly. A dipole antenna 530 can be supported on printed circuit board 514 by standoffs. In the present embodiment, dipole antenna 530 can transmit a dipole electromagnetic field 532 that can be modulated with any desired data that is generated by the transmitter assembly including, for example, sensor derived data such as pressure, temperature, positional orientation and/or accelerometer-based data. With regard to the latter, an air module 540 is positioned adjacent to the end of the dipole antenna and printed circuit board. It should be appreciated that an antenna is not a requirement since some embodiments may not transmit an electromagnetic signal but rather transmit information up a drill string, as described for example, in U.S. Pat. No. 7,028,779 using a wire-in-pipe arrangement or U.S. patent application Ser. No. 13/071,302 using the drill string as an electrical conductor, both of which are incorporated herein by reference. As will be further described, air module 540 defines an interior cavity which receives aforedescribed accelerometer module 60. An end 542 of the printed circuit board can carry interface 62 (see FIG. 3) from processor 514 for connection to the accelerometer module.

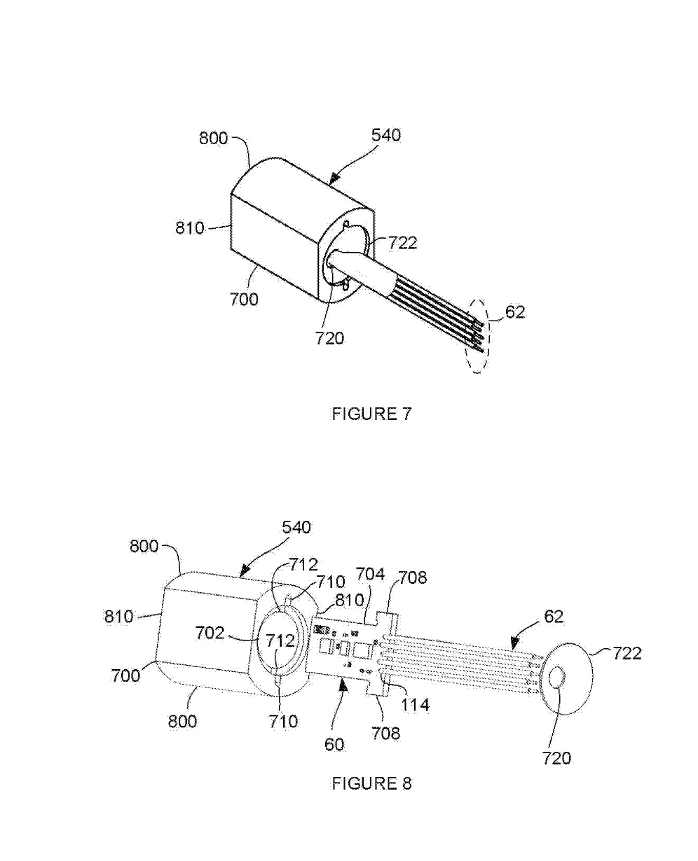

Referring to FIGS. 7 and 8, the former illustrates an embodiment of air module 540 in a diagrammatic assembled perspective view while the latter illustrates the embodiment in a diagrammatic perspective exploded view. A housing 700 is configured for receiving accelerometer module 60 within an interior cavity 702. The housing can be formed from any suitable material such as, for example, polycarbonate. The accelerometer module includes a printed circuit board 704 having opposing tabs 708 that are receivable in opposing grooves 710 of the housing. Interior grooves 712 can slidingly receive a main body of the printed circuit board. The printed circuit board can be held in an installed position, for example, using a limited amount of a suitable adhesive that is applied to the interior floor of housing 700 and can be applied to tabs 708. With the printed circuit board received in the housing, electrical conductors extending from interface 114 can be bundled and passed through an opening 720 that is defined by an end cover 722. The latter can be fixed onto the housing body, for example, using a suitable adhesive/sealant such as, for example, an RTV silicone. The same or a different adhesive/sealant can be applied to seal opening 720 with the electrical conductors fitted therethrough so as to prevent the intrusion of a potting compound that can be applied, as will be described hereinafter.

Referring to FIGS. 5-8, housing 700 includes opposing curved surfaces 800 that can be configured to engage the interior surface of main body housing 502, for example, using an interference or other suitable fit. With the accelerometer module electrically connected to printed circuit board 514, a potting compound 802 (diagrammatically shown in FIG. 6) is installed within the transmitter housing so as to fill any remaining voids in the assembly and end cap 512 is installed. In this way, the potting compound also flows into voids between opposing surfaces 810 of housing 800 and the interior sidewalls of main housing body 502. The term “air module” refers to the fact that the accelerometer or accelerometers of the accelerometer module are effectively supported only by the accelerometer printed circuit board. That is, that portion of the interior of the air module which is not taken up by the accelerometer module is left empty and is not filled with any sort of shock mitigation material. It should be appreciated that the traditional approach that has been taken in the prior art resides in attempting to shock mount the accelerometer module, for example, using a foam support configuration. Applicants have discovered, however, that the foam itself is not insensitive to temperature changes and can introduce errors in accelerometer outputs as a result of this insensitivity. Further, Applicants have empirically demonstrated that the shock mounting techniques of the prior art are of limited value with respect to modern accelerometers while the air module has provided for performance that could be characterized as exceptional. For example, it has been demonstrated that the combined performance of using external compensation with the air module assembly has yielded accelerometer errors to within +/−1 mg, in some cases. It is noted that 1000 mg is equal to the force of gravity or 1 g.

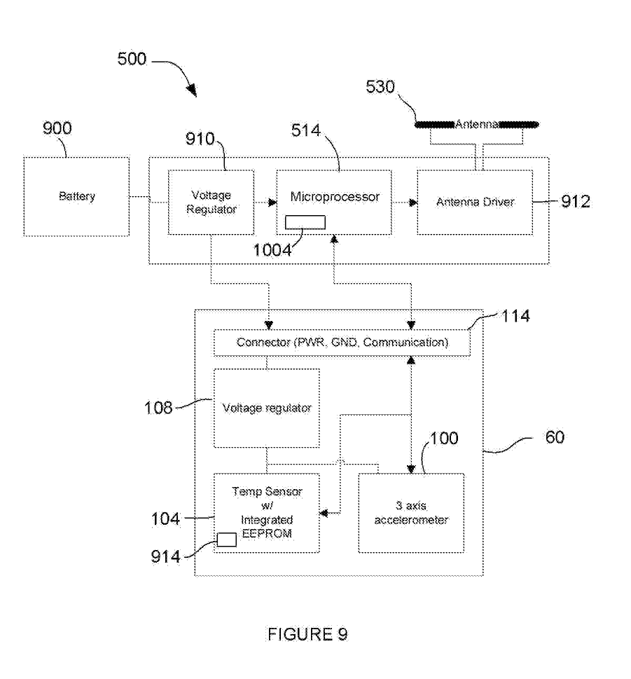

FIG. 9 is a block diagram of an embodiment of inground device 500 including accelerometer module 60, as described above. Additionally, a battery 900 is illustrated as well as a voltage regulator 910 and an antenna driver 912. It should be appreciated that compensation data 914 such as, for example, the coefficients described above is stored in the memory of temperature sensor 104 or any suitable location.

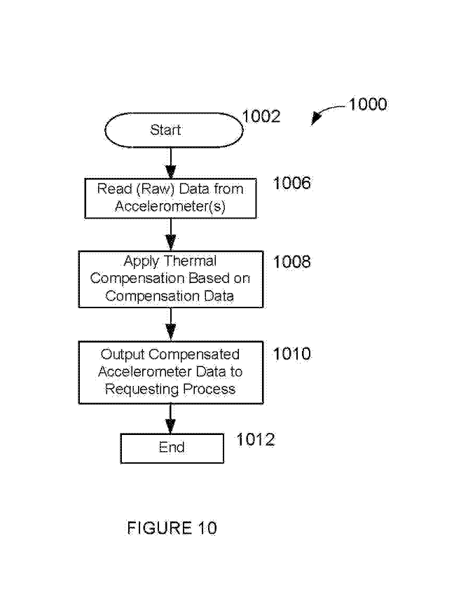

FIG. 10 is a flow diagram that illustrates an embodiment of a method, generally indicated by the reference number 1000, for the operation of inground device 500 according to the present disclosure. The method is invoked for purposes of reading data from the accelerometer module and begins at start 1002. This step can involve any necessary initialization or preparatory steps responsive, for example, to power up. In an embodiment, microprocessor 514 can initially read compensation data and store the data in a local memory 1004 such as, for example, a memory cache in order to improve processing throughput, although this is not required. The method proceeds to 1006 wherein what can be referred to as raw accelerometer data is read from the accelerometer module. Of course, the term raw accelerometer data refers to thermally uncompensated data. At 1008, microprocessor 516 can apply thermal compensation to the raw accelerometer data based, for example, on coefficients that comprise compensation data 914 in conjunction with the expressions for OS(t) and k(t) determined above. The compensated accelerometer data, at 1010, is provided to any process that requires the data such as, for example, for determining orientation outputs such as pitch and/or roll or for monitoring shock and/or vibration. Of course, the compensated accelerometer data is not limited to these specific functions and may be used by any requesting process. Applicants are not aware of such external compensation for accelerometer thermal drift in the prior art. As discussed above, the method and associated apparatus that has been brought to light herein provides for remarkable flexibility in the selection of native accelerometer performance as well as the opportunity to virtually enhance the effective thermal performance of any given accelerometer.

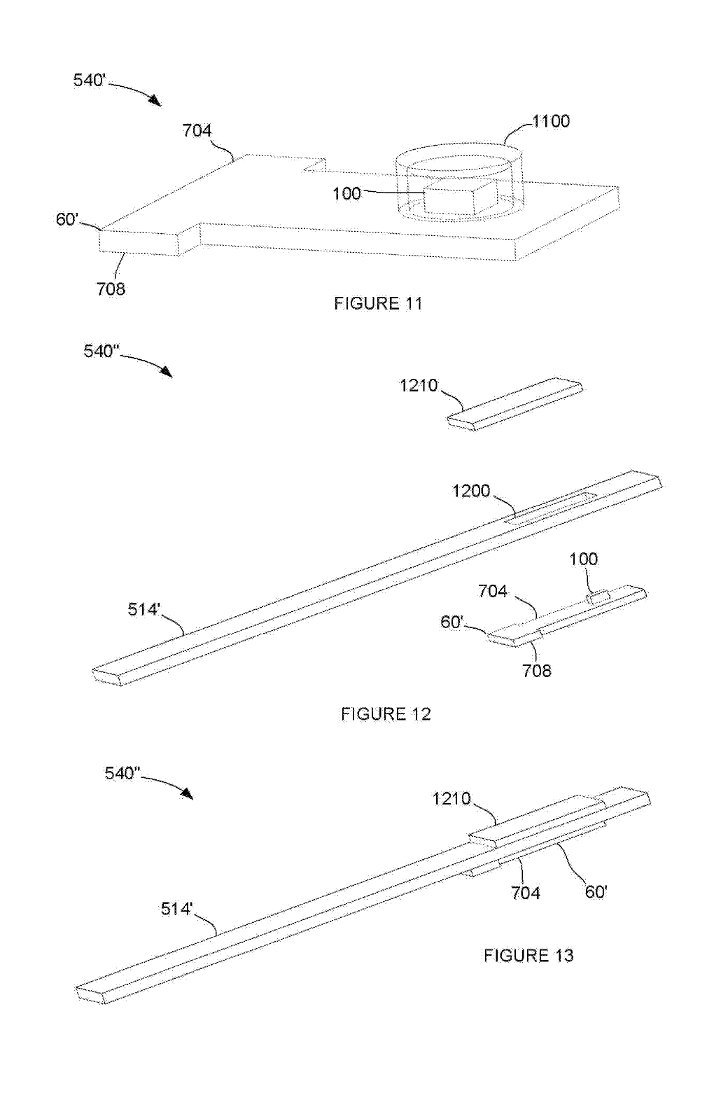

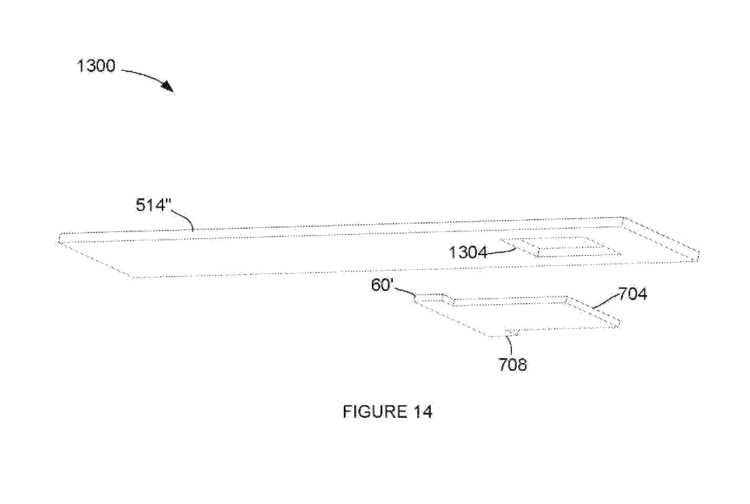

Referring to FIG. 11, another embodiment of an air module is generally indicated by the reference number 540′ and is shown in a diagrammatic perspective view. In particular, this embodiment is formed in cooperation with printed circuit board 704 of accelerometer module 60′ by installing a dome or capsule 1100 onto the printed circuit board to enclose accelerometer(s) 100 in a cavity such that the accelerometer is isolated from potting compounds as well as from contact with other materials that may exhibit a thermal response that would influence the accelerometer. It is noted that capsule 1100 has been rendered as transparent for illustrative purposes. The capsule can be attached to the printed circuit board, for example, using a suitable adhesive such as an RTV silicone or an epoxy. Any sealing/attachment expedients may be employed so long as the entrance of potting compound is sufficiently mitigated at least during the cure time of the potting compound. In some embodiments, the interior of the capsule can include a support material that exhibits a very low coefficient of thermal expansion such as, for example, polycarbonate. Such a material can be used without the need for the capsule itself, so long as it is capable of resisting penetration by a surrounding potting compound. Accelerometer module 60′ is not required to include tabs 708 and can include any suitable peripheral outline since the module, in an embodiment, can be mounted on stand-offs in the manner of printed circuit board 514 (see FIG. 6) within the inground device. Capsule 1100 can itself be formed from any suitable material such as, for example, a polycarbonate plastic. In some embodiments, the accelerometer(s) and capsule can be installed directly onto main circuit board 514.

Referring to FIG. 12, a diagrammatic perspective, exploded view is shown which illustrates another embodiment of an air module, generally indicated by the reference number 540″, and formed through the cooperation of the illustrated components. An embodiment of the main printed circuit board is indicated by the reference number 514′ and can define a through opening 1200. The latter is configured so as to be smaller in lateral extents than accelerometer module 60′ but, like the accelerometer module, can include any suitable peripheral outline and is not limited to the rectangular outline that is shown. The accelerometer module can include any suitable peripheral outline and is not required to include tabs 708, as discussed above. Printed circuit board 704 of the accelerometer module can include any suitable features for purposes of electrically connecting to main board 514′ including, but not limited to solder connections, wiring pigtails, a connector for mating with a complementary connector on the main board or any suitable combination of these features. A cover 1210 is shown on an opposite side of the main board with respect to accelerometer module 60′. The lateral extents or peripheral outline of the cover, like accelerometer board 704, can be sized such that an edge margin of the cover is receivable against an edge margin of the main board surrounding through opening 1200. The cover can be formed from any suitable material such as, for example, from plastic sheet material, such as a polycarbonate or G10-FR4 (fiberglass) which is a typical printed circuit board material. There is no requirement, however, for the cover or accelerometer board to be formed of a sheet material having coplanar surfaces. In an embodiment, suitable non-planar features can be provided such as, for example, sealing features including but not limited to a sealing ring or lip. In another embodiment, one or both of the accelerometer module and the cover can include features such as, for example, resilient clips for engaging the main board and/or one another for mounting/retaining purposes to provide sufficient support at least until adhesives/sealants cure.

Turning to FIG. 13 in conjunction with FIG. 12, the former illustrates a perspective diagrammatic assembled view of air module 540″ having main board 514′ partially sandwiched between accelerometer module 60′ and cover 1210. Accordingly, accelerometer(s) 100 is therefore received in an accelerometer cavity. Any suitable adhesive sealant can be applied for purposes of sealing each of the accelerometer module and cover to main board 514′ including RTV silicone or a similarly performing adhesive, so long as a potting material (item 802 in FIG. 6) is prevented from entering the accelerometer cavity at least during the cure time of the potting material. Of course, the air module can be assembled on main board 514′ and then the assembly can be installed into inground device 500 of FIG. 6 in any suitable manner such as, for example, by using standoffs, as described above.

Referring to FIG. 13, a diagrammatic perspective, exploded view is shown which illustrates another embodiment of an air module, generally indicated by the reference number 1300, and formed through the cooperation of the illustrated components. Another embodiment of the main printed circuit board is indicated by the reference number 514″ and can define a pocket 1304 which does not extend completely through the thickness of the board. Accordingly, cover 1210 of FIGS. 11 and 12 is not needed in this embodiment. The pocket is configured so as to be smaller in lateral extents than accelerometer module 60′ but, like the accelerometer module, can include any suitable peripheral outline and is not limited to the rectangular outline that is shown. The pocket can be formed, for example, by machining. In some cases, a relatively thicker printed circuit board can be used for purposes of increasing the depth of the pocket to house a particular arrangement of electronic components on the accelerometer module. The accelerometer module can include any suitable peripheral outline and is not required to include tabs 708, as discussed above. Printed circuit board 704 of the accelerometer module can include any suitable features for purposes of electrically connecting to main board 514″.

It should be appreciated that the air module, as demonstrated by the various embodiments that have been brought to light herein, can be provided in a wide range of different embodiments by one of ordinary skill in the art having the present disclosure in hand. All of these embodiments are considered to fall within the scope of the present disclosure. At least one feature that is common to all of these embodiments resides in isolating the accelerometers or accelerometers from a surrounding potting compound such that the accelerometer(s) are subjected to a thermal response that is different from the thermal response that the accelerometer(s) would otherwise be subjected to or encounter in direct contact with the potting compound. Yet the benefits of the potting compound are retained by preventing exposure of the accelerometer(s) to a potentially hostile ambient drilling environment.

The foregoing description of the invention has been presented for purposes of illustration and description. It is not intended to be exhaustive or to limit the invention to the precise form or forms disclosed, and other embodiments, modifications and variations may be possible in light of the above teachings wherein those of skill in the art will recognize certain modifications, permutations, additions and sub-combinations thereof.

What is claimed is:

1. A device for use in performing an inground operation, said device comprising:
at least one accelerometer for generating accelerometer readings that characterize an operational condition of the device during the inground operation, which accelerometer readings are subject to a native temperature drift that is a characteristic of the accelerometer;
a set of compensation data for use in compensating for said native temperature drift; and
a processor that is configured to apply said compensation data to said accelerometer readings to produce accelerometer readings that compensate for said native temperature drift.

2. The device of claim 1 wherein the operational condition is an orientation parameter of the device.

3. The device of claim 1 including a memory for storing said compensation data locally with the accelerometer and wherein said processor is separated from the accelerometer and the memory by at least one interface.

4. The device of claim 3 wherein the interface is an I²C interface.

5. The device of claim 1 wherein said compensation data comprises a set of coefficients.

6. The device of claim 5 wherein said set of compensation coefficients includes ten coefficients.

7. The device of claim 5 wherein said set of coefficients characterize a temperature range from −20° C. to +60° C.

8. The device of claim 5 wherein said processor is configured to apply the set of coefficients based on an offset function and a gain function.

9. The device of claim 1 wherein said accelerometer and said set of compensation data are carried by a module that is receivable in an end use device that includes said processor such that the set of compensation data is determined by a different processor that is not part of the end use device.

10. The device of claim 9 wherein said module further includes a temperature sensor for monitoring a temperature of the accelerometer and a voltage regulator to provide regulated electrical power to the accelerometer.

11. A device for use in performing an inground operation, said device comprising:
at least one accelerometer for generating accelerometer readings that characterize an operational condition of the device during the inground operation, which accelerometer readings are based on a given thermal performance that is associated with the accelerometer;
a set of compensation data that characterizes the given thermal performance of the accelerometer; and
a processor that is configured to apply said compensation data to said accelerometer readings to produce compensated accelerometer readings that correspond to an enhanced thermal performance that is improved as compared to the given thermal performance.

12. The device of claim 11 wherein said enhanced thermal performance is a reduced deviation from absolute accuracy with changes in temperature.

13. A method for producing an enhanced thermal performance for a given accelerometer that is characterized by a given thermal performance with the given accelerometer installed in a device for performing an inground operation, said method comprising:
generating accelerometer readings from the given accelerometer that characterize an operational condition of said device during the inground operation, which accelerometer readings are based on the given thermal performance that is associated with the given accelerometer;
accessing a set of compensation data that characterizes the given thermal performance of the given accelerometer; and
applying said compensation data to said accelerometer readings to produce thermally compensated accelerometer readings that correspond to an enhanced thermal performance which is improved as compared to the given thermal performance.

14. The method of claim 13 further comprising:
generating said compensation data before installing the given accelerometer in said device.

15. The method of claim 14 wherein generating includes establishing said compensation data in a temperature range from −20° C. to +60° C.

16. The method of claim 13 wherein said compensation data includes a set of coefficients and the method includes applying the coefficients based on an offset function and a gain function to produce the thermally compensated accelerometer readings.

17. A method for thermal calibration of a triaxial accelerometer including a set of three orthogonally oriented accelerometers arranged along orthogonal X, Y and Z sensing axes, said method comprising:
supporting the triaxial accelerometer for selective rotation about the orthogonal sensing X, Y and Z axes such that the triaxial accelerometer is orientable in at least twelve different positions for orienting each of the X, Y and Z sensing axes at least approximately to receive four different cardinal gravity-based accelerations;
exposing the triaxial accelerometer to a selected temperature; and
with the triaxial accelerometer at the selected temperature, measuring outputs of each of the X, Y and Z accelerometers for every cardinal gravity-based acceleration using no more than seven rotational positions of the triaxial accelerometer selected from said sixteen positions.

18. In a device for use in performing an inground operation with said device including a device housing defining a device interior that carries at least one accelerometer to characterize the inground operation and the device is subjected to an operational environment during the inground operation that is characterized by an operational thermal environment, said housing interior being substantially filled by a potting material to fill the housing interior except for any regions that are not accessible to the potting material, an accelerometer support arrangement comprising:
a housing that is sealed within the device interior and which housing defines a housing cavity; and
an accelerometer module defining a support surface that is configured to support said accelerometer and to form an electrical interface with the accelerometer and said accelerometer is fixedly supported within said housing cavity within a void at least extending from the support surface and surrounding the accelerometer to isolate the accelerometer from the potting material and from thermal expansion that would otherwise be received from a material within a volume of said void.

19. The arrangement of claim 18 wherein the support surface is defined by a printed circuit board that is in electrical communication with the accelerometer.

20. The arrangement of claim 19 wherein said housing cavity is defined by a capsule that is configured to receive the printed circuit board.

21. The arrangement of claim 19 wherein said capsule includes an entrance opening for installing the printed circuit board within the housing cavity.

22. The arrangement of claim 21 wherein said capsule is formed from polycarbonate.

23. The arrangement of claim 19 wherein a different printed circuit board serves as said housing and the different printed circuit board defines a pocket within a thickness of the different printed circuit board to serve as the housing cavity.

24. The arrangement of claim 23 wherein said printed circuit board is sealed against a peripheral region of the different printed circuit board surrounding the pocket to position the accelerometer within the housing cavity.

25. The arrangement of 19 wherein a different printed circuit board defines a through opening that extends through a thickness of the different printed circuit board to partially define the housing cavity in cooperation with a cover that seals a first entrance opening of the housing cavity.

26. The arrangement of claim 25 wherein said printed circuit board is sealed against a peripheral region of the different printed circuit board surrounding a second, opposite entrance opening of the housing cavity.

27. In a device for use in performing an inground operation with said device including a device housing defining a device interior that carries at least one accelerometer to characterize the inground operation and the device is subjected to an operational environment during the inground operation that is characterized by an operational thermal environment, said housing interior being substantially filled by a potting material to fill the housing interior except for any regions that are inaccessible to the potting material, a method comprising:
forming a housing that is sealed within the device interior at least in part by the potting compound and which housing defines a housing cavity; and
arranging an accelerometer module having a support surface that supports said accelerometer to form an electrical interface with the accelerometer such that the accelerometer is supported within said housing cavity within a void at least extending from the support surface and surrounding the accelerometer to isolate the accelerometer from the potting material and from thermal expansion that would otherwise be received from a material within a volume of said void.
